(19) United States
(12) Patent Application Publication
(10) Pub. No.: US 2012/0154129 A1
(43) Pub. Date: Jun. 21, 2012

(54) REMOTE CONTROL FOR ELECTRONIC DEVICE AND SIGNAL TRANSMISSION METHOD THEREOF

(75) Inventors: KUAN-HONG HSIEH, Tu-Cheng (TW); HAN-CHE WANG, Tu-Cheng (TW); BO-CHING LIN, Tu-Cheng (TW); XIN ZHAO, Shenzhen City (CN); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO. LTD., Shenzhen City (CN)

(21) Appl. No.: 13/086,337

(22) Filed: Apr. 13, 2011

(30) Foreign Application Priority Data
Dec. 21, 2010 (CN) 201010598580.0

(51) Int. Cl. G08C 19/16

(52) U.S. Cl. 340/12.22

(57) ABSTRACT

A remote control for an electronic device comprises an input unit for generating control signals, a connector and a microprocessor. A connector with a plurality of interfaces, one end of connector is electrically connected to a transmission unit of the remote control via a data bus, each of the interfaces of the connector is configured for engaging with an interface of the electronic device for transmitting the control signals to the electronic device. The microprocessor determines which interface to transmit the control signals to the electronic device to control the electronic device to flip pages. A signal transmission method applied in a remote control for an electronic device is also provided.

### BACKGROUND

1. Technical Field

The present disclosure relates to remote controls and, particularly, to a remote control for an electronic device and a signal transmission method employed in the remote control.

2. Description of the Related Art

Many electronic devices provide mechanical buttons for devices to input commands. However, repetitive operations may cause users to feel tired, and in addition, the mechanical buttons occupy space, thus making miniaturization difficult.

### BRIEF DESCRIPTION OF THE DRAWINGS

The components of the drawings are not necessarily drawn to scale, the emphasis instead being placed upon clearly illustrating the principles of a remote control for electronic device and a signal transmission method for the remote control. Moreover, in the drawings, like reference numerals designate corresponding parts throughout multiple views.

FIG. 1 is a schematic view of an electronic device and a remote control accompanying the electronic device in accordance with an exemplary embodiment.

FIG. 2 is a block diagram of a hardware infrastructure of the electronic device and the remote control of FIG. 1.

FIG. 3 is a flowchart of a signal transmission method applied in the remote control of FIG. 1.

FIG. 4 is a flowchart of a remote control method applied in the electronic device of FIG. 1 in accordance with an exemplary embodiment.

### DETAILED DESCRIPTION

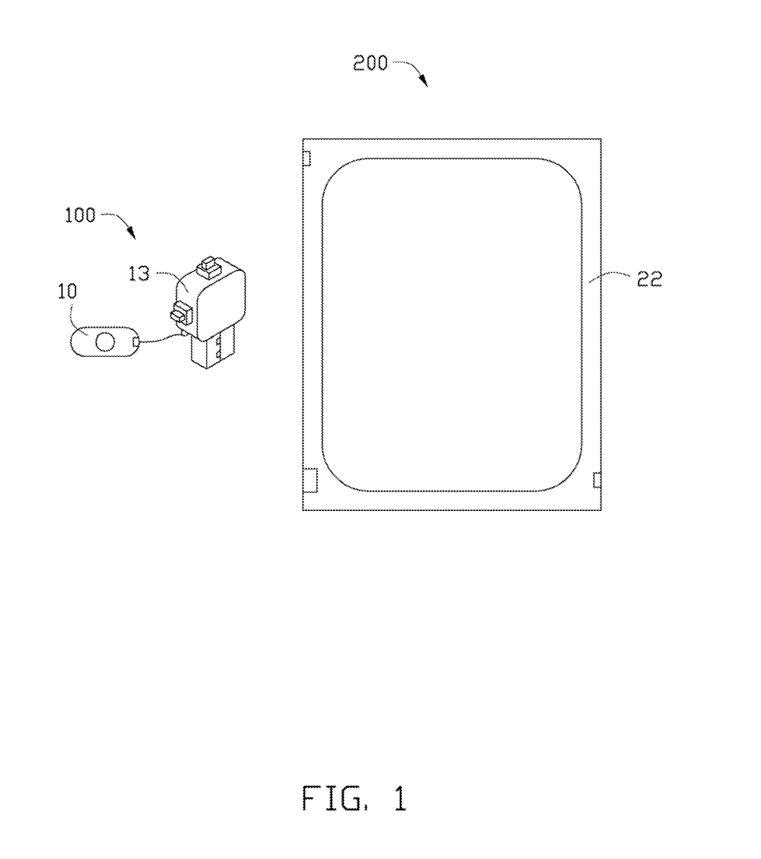

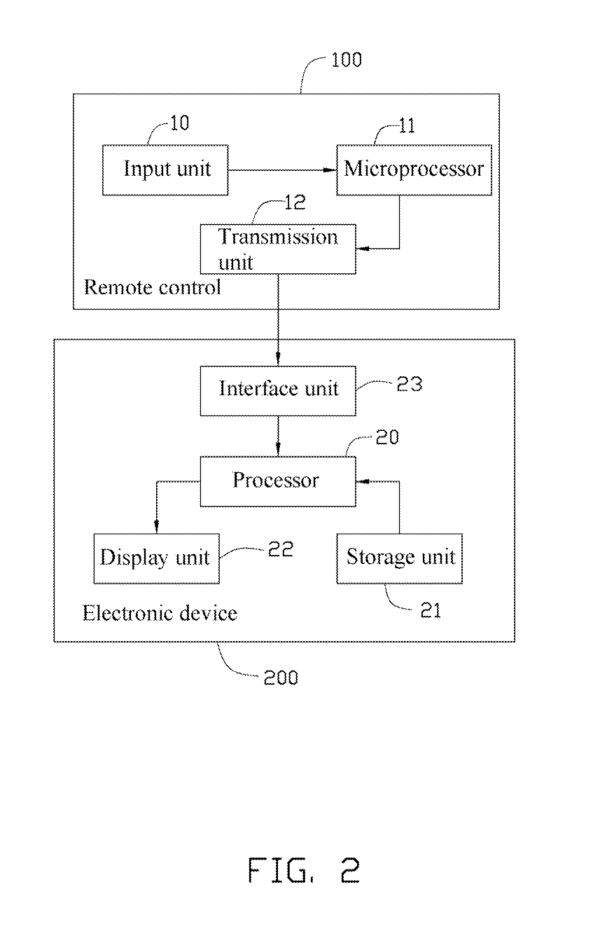

Referring to FIGS. 1 and 2, a remote control 100 is configured to control an electronic device 200 to flip pages. In the embodiment, the remote control 100 is a cable remote control. The remote control 100 includes an input unit 10, a microprocessor 11, a connector 13 and a transmission unit 12. The input unit 10 is configured for generating control signals in response to input operations. The transmission unit 12 transmits the control signals to electronic device 200 via the connector 13. The connector 13 with various interfaces is electrically connected to transmission unit 12 of the remote control 100 via a data bus, and each of the interfaces of the electronic device 200 corresponds to one of the various interfaces of the connector 13 for transmitting the control signals between the remote control 100 and the electronic device 200. The microprocessor 11 determines which interface of the connector 13 is electrically connected to the electronic device 200 and transmits the control signals from the input unit 10 to the electronic device 200 via this interface.

In the embodiment, the input unit 10 is a button, users can operate the button in various operation ways to control the electronic device 200 to flip pages. The microprocessor 11 scans all the interfaces of the connector 13 to obtain level signals of those interfaces to determine which interface is connected to the electronic device 200.

The microprocessor 11 then controls the transmission unit 12 to transmit control signals to the electronic device 200 via the determined interface.

The electronic device 200 includes a control unit 20, a storage unit 21, a display unit 22 and interface unit 23. In the embodiment, the interface unit 23 includes a data transmission interface, an earphone interface, and a battery charging interface.

Each interface of the interface unit 23 can be engaged to one of the interfaces of the connector 13. Thus, the electronic device 200 can receive the operation signals transmitted by the remote control 100 via any interface electrically connected to the connector 13. The storage unit 21 stores digital files. The processor 20 receives the operation signals from the remote control 100 to control the electronic device 200 to flip pages. The processor 20 determines an operation type according to the Pulse Width Modulation (PWM) waves of the control signals. If the operation is the first type, the processor 20 flips a page forward. If the operation is the second type, the processor 20 flips a page backwards. If the operation is the third type, the processor 20 returns to the homepage of a current file and updates the content on the display unit 22 accordingly.

In the embodiment, if the control signal exists beyond a first preset time period, but not beyond a second preset time period, such as 2 ms<t≦500 ms, the processor 20 determines that the operation is the first type; if control signals exist beyond the second preset time period, but not beyond a third preset time period, such as 500 ms<t≦2000 ms, the processor 20 determines that the operation is the second type; if the control signal exists beyond the third preset time period, such as t>2000 ms, the processor 20 determines that the operation is the third type.

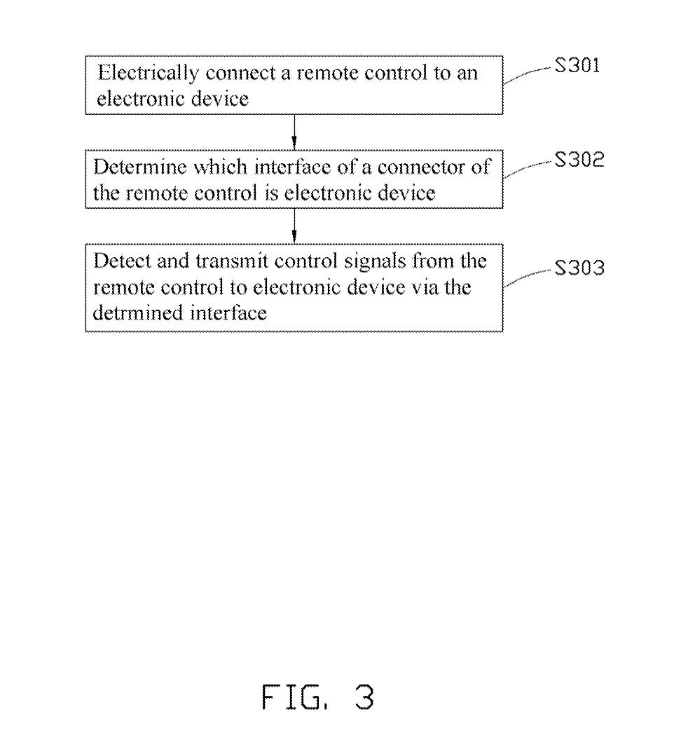

Referring to FIG. 3, shows a signal transmission method of a remote control accompanying an electronic device in accordance with an exemplary embodiment. The remote control includes a connector 13 with various interfaces.

In step S301, electrically connecting a remote control 100 to an electronic device 200.

In step S302, the remote control 100 determines which interface of the connector 13 of the remote control 100 is electrically connected to the electronic device 200. In the embodiment, a microprocessor 11 of the remote control 100 scans each interface of the connector 13 to obtain level signals of the interface to determine which interface is connected to the electronic device 200.

In step S303, the remote control 100 detects and transmits control signals from an input unit 10 to the electronic device 200 via the determined interface.

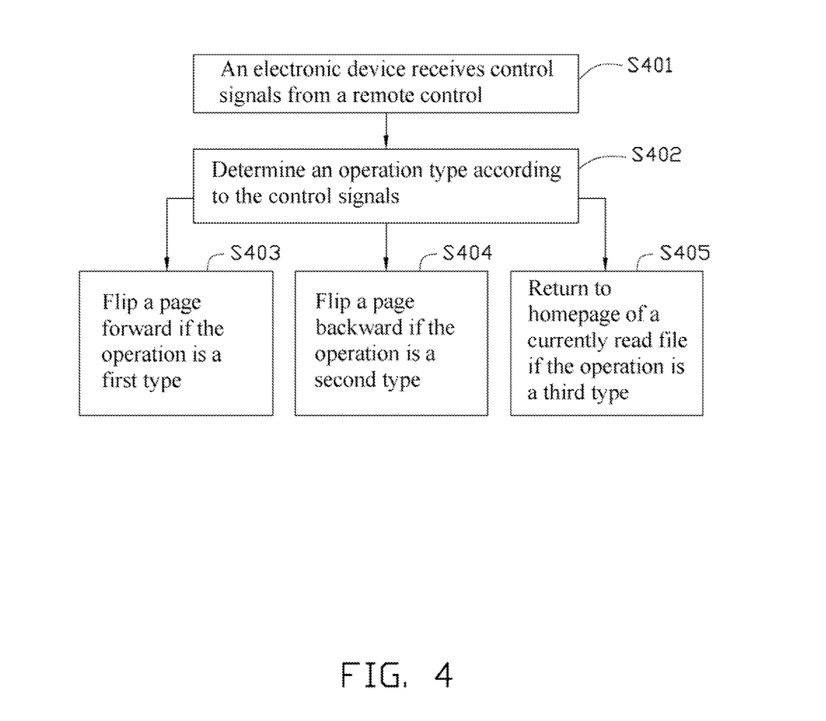

Referring to FIG. 4, FIG. 4 shows a remote control method of an electronic device in accordance with an exemplary embodiment.

In step S401, an electronic device 200 receives control signals from a remote control 100 accompanying the electronic device 200.

In step S402, the electronic device 200 determines an operation type according to the Pulse Width Modulation (PWM) waves of the control signals.

In step S403, the electronic device 200 flips a page forward if the operation is a first type.

In step S404, the electronic device 200 flips a page backward according to the operation signal if the operation is a second type.

In step S405, the electronic device 200 returns to homepage of a current file according to the operation signal if the operation is a third type.

In the embodiment, if the control signal exists beyond a first preset time period, but not beyond a second preset time period, such as 2 ms<t≦500 ms, the microprocessor 11 determines that the operation is the first type; if the control signal exists beyond the second preset time period, but not beyond a third preset time period, such as 500 ms<t≦2000 ms, the microprocessor 11 determines that the operation is the second type; if the control signal exists beyond the third preset time period, such as t>2000 ms, the microprocessor 11 determines that the operation is the third type.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A remote control for an electronic device comprising:
an input unit configured for generating control signals;
a connector with a plurality of interfaces, one end of connector being electrically connected to a transmission unit of the remote control via a data bus, and each of the interfaces of the connector is configured for engaging with an interface of the electronic device for transmitting the control signals to the electronic device; and
a microprocessor configured for determining which interface of the connector is electrically connected to the electronic device and transmitting the control signals from the input unit to the electronic device via the determined interface to control the electronic device to flip pages.

2. The remote control as described in claim 1, wherein the remote control controls the electronic device to flip a page forward or flip a page backward, or return to the homepage of a current file.

3. The remote control as described in claim 1, wherein the microprocessor scans each interface of the connector to obtain level signals of the interface to determine which interface is connected to the electronic device according to values of the level signals.

4. The remote control as described in claim 1, wherein the input unit is a button configured for users to operate to control the electronic device to flip pages.

5. A signal transmission method applied to a remote control for an electronic device, comprising:
electrically connecting the remote control to an electronic device via a connector of the remote control;
determining which interface of the connector is electrically connected to the electronic device;
detecting control signals generated by an input unit of the remote control; and
transmitting the control signals to the electronic device to control the electronic device to flip pages via the determined interface.

6. The signal transmission method as described in claim 5, wherein flipping pages in the transmitting step comprises flipping a page forward, flipping a page backward, or returning to the homepage of a current file.

7. The signal transmission method as described in claim 5, wherein the determining step comprises scanning all the interfaces of the connector to obtain level signals of each interface to determine which interface is connected to the electronic device according to values of the level signals.
